(19) United States
(12) Patent Application Publication
(10) Pub. No.: US 2012/0254054 A1
(43) Pub. Date: Oct. 4, 2012

(54) NETWORK BASED EMPLOYMENT ELIGIBILITY AND VERIFICATION SYSTEM WITH ELECTRONIC DOCUMENT MANAGEMENT

(75) Inventor: Robert C. Meltzer, Chicago, IL (US)

(73) Assignee: VISANOW.COM, INC., Chicago, IL (US)

(21) Appl. No.: 13/079,251

(22) Filed: Apr. 4, 2011

(51) Int. Cl. G06Q 10/00

(52) U.S. Cl. 705/321

(57) ABSTRACT

A network based system, providing employment eligibility and verification services, includes a file management interface and a module. The file management interface is configured to display at least one account along with a status of the account. The module is configured to communicate with E-verify to validate information that has been electronically received with respect to the account. The system is configured to check that an expiration date of a submitted document of the account is valid prior to communicating with E-verify regarding the account. The system is also configured to update the status of the account on the file management interface based on a result provided by E-verify.

### TECHNICAL FIELD

The present invention relates generally to a network based system for receiving and providing data relating to employment eligibility and verification with electronic document management.

### BACKGROUND

In the United States, employers must complete an Employment Eligibility Verification Form (“I-9 form”), provided by the federal government, for newly hired employees within three days of their employment start date. The I-9 form involves verifying the employee's identity and the employee's legal authorization to accept employment in the United States.

Along with ensuring that I-9 forms are completed for newly hired employees, employers are required to retain I-9 forms of all current employees, and all former employees until the latter of three years after the employee is hired or one year after the employee's employment ends. Also, in certain instances, employers are required to re-verify certain documents associated with the I-9 forms on or before their expiration dates.

In addition, employers may be audited with respect to their compliance with all necessary I-9 requirements. Employers, which are discovered to be in I-9 noncompliance, may be penalized, such as by fines and/or imprisonment.

Generally, employers have their human resources (“HR”) departments handle employment related matters, such as the processing and management of I-9 forms. However, processing I-9s, ensuring I-9 compliance, and/or responding to an I-9 audit request may consume a significant amount of time and resources of an HR department, which also handles other personnel matters.

### SUMMARY OF THE INVENTION

Disclosed herein are one or more inventions that provide a plurality of means by which a user may submit I-9 information, confirm receipt of this information, and provide a means by which a user may access, track, and manage the submitted information.

In one embodiment, a network based system, providing employment eligibility and verification services, includes a first interface, a second interface, and a file management interface. The first interface is configured to obtain a first set of information to be associated with an account and stored in a database. The first interface is privileged to a first user of the system. The second interface is configured to obtain a second set of information to be associated with the account and stored in the database. The second interface is privileged to a second user of the system. The file management interface is configured to display a link to the account and a status of the account. The audit log is configured to capture an action that is taken with respect to the account. The file management interface includes a link to the audit log.

In one embodiment, a network based system, providing employment eligibility and verification services, includes a user interface and a module. The file management interface is configured to display at least one account along with a status of the account. The module is configured to communicate with E-verify to validate information that has been electronically received with respect to the account. The system is configured to (a) check that an expiration date of a submitted document of the account is valid prior to communicating with E-verify regarding the account, and (b) update the status of the account on the file management interface based on a result provided by E-verify.

In one embodiment, a network based system, providing employment eligibility and verification services, includes a file management interface. The file management interface is configured to display a listing of I-9 account information that identifies I-9 accounts and provides statuses of the corresponding I-9 accounts. The file management interface is configured to provide a status search field via which search results may be generated as the listing of I-9 account information based upon search criteria relating to a status of an I-9 account. The file management is configured to provide links to a set of programs. When a program from the set of programs is selected, the system is configured to provide the I-9 account information displayed in the file management interface to the selected program to generate a report of the I-9 account information in a format of the selected program.

These and other features and aspects of the invention are set forth in greater detail below in the following detailed description of the presently preferred embodiment with reference to the accompanying drawings.

### BRIEF DESCRIPTION OF THE DRAWINGS

The present invention can be better understood with reference to the following drawings. The components in the drawings are not necessarily to scale, emphasis instead being placed upon clearly illustrating the principles of the present invention.

FIG. 1 is a graphical representation of one embodiment of a system in which the present invention may be practiced;

FIG. 2 is an illustration of an exemplary user interface that is configured to enable the creation of an I-9 form;

FIGS. 3A-3B illustrate an exemplary user interface that is configured to receive information relating to section 1 of the I-9 form;

FIG. 4 is an illustration of an exemplary user interface that is configured to receive information relating to section 2 of the I-9 form;

FIG. 5 is an illustration of an exemplary user interface that is configured to receive information relating to section 3 of the I-9 form;

FIG. 6 is a listing of statuses that may be associated with an I-9 that is accessible via the system;

FIG. 7 is an illustration of an exemplary user interface that displays I-9 forms that are considered “active;”

FIG. 8 is an illustration of an exemplary user interface that displays I-9 forms that are considered “complete;”

FIG. 9 is an illustration of an exemplary audit log relating to an employee account; FIG. 10 is an illustration of an exemplary user interface of a customer support system to assist users with the I-9 process; and

FIG. 11 is an illustration of an exemplary user interface that allows a user to request an I-9 audit report.

### DETAILED DESCRIPTION

The description that follows describes, illustrates, and exemplifies one or more particular embodiments of the present invention in accordance with its principles. This description is not provided to limit the invention to the embodiments described herein, but rather to explain and teach the principles of the invention in such a way to enable one of ordinary skill in the art to understand these principles and, with that understanding, be able to apply them to practice not only the embodiments described herein, but also other embodiments that may come to mind in accordance with these principles. The scope of the present invention is intended to cover all such embodiments that may fall within the scope of the appended claims, either literally or under the doctrine of equivalents.

It should be noted that in the description and drawings, like or substantially similar elements may be labeled with the same reference numerals. However, sometimes these elements may be labeled with differing numbers, such as, for example, in cases where such labeling facilitates a more clear description. Additionally, the drawings set forth herein are not necessarily drawn to scale, and in some instances proportions may have been exaggerated to more clearly depict certain features. Such labeling and drawing practices do not necessarily implicate an underlying substantive purpose. As stated above, the present specification is intended to be taken as a whole and interpreted in accordance with the principles of the present invention as taught herein and understood to one of ordinary skill in the art.

In a broad sense, the present invention essentially provides a means for automating the gathering, receiving, displaying, and managing of information relating to I-9 applications over a network, preferably the Internet. More particularly, the invention provides a means for the delivery of services, e.g., legal services, via the world wide web.

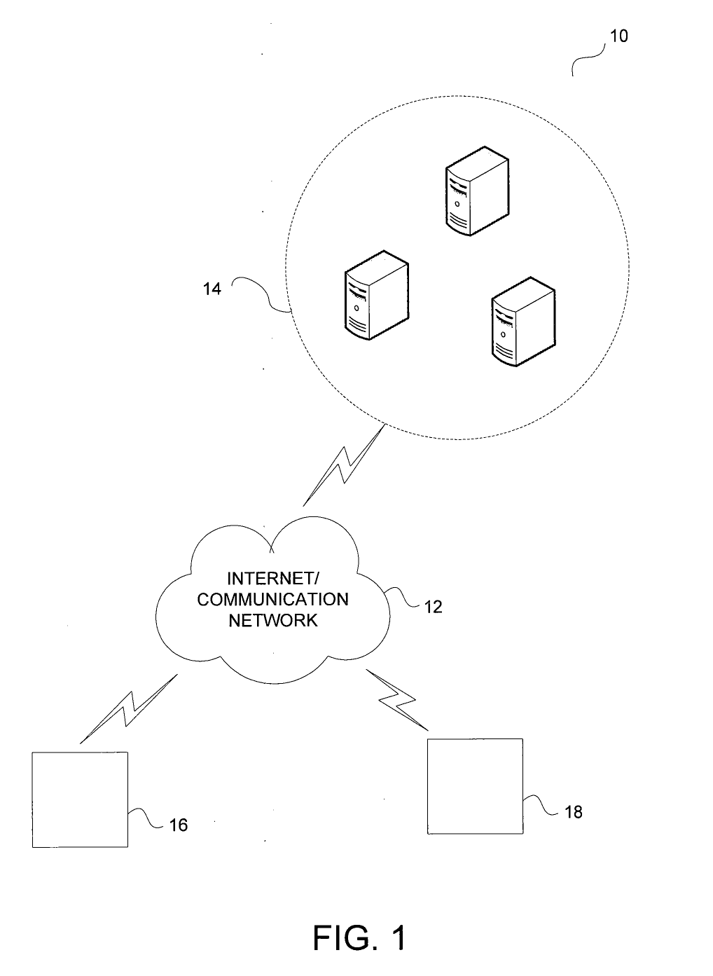

FIG. 1 is a graphical representation of one embodiment of a system in which the present invention may be practiced. System 10 comprises a network 12 such as the Internet or other suitable network, albeit private or public. Connected to the network 12 by suitable means is a server (or group of servers) 14 on which are stored a legal service provider's files, some of which are to be accessed by a remote or client computer 16. Remote computer 16 is referred to herein also as a client computer, or simply client, when appropriate. Further a person or user accessing the files via the client computer can be referred as a client (or, more appropriately, a potential client in a legal engagement context). Distinctions herein, to the extent important, generally should be readily understood. Finally, there is also illustrated a remote administrator's computer 18 which also can access files on the server 14.

As can be appreciated, computers 16 and 18 can be connected to the network in a variety of ways, e.g., via direct connection. Since the system herein is described in terms of an application system that provides employment eligibility and verification services, as well as document management, it is envisioned that most of the connections of the remote computers to network 12 will be made via an Internet access provider account.

In that regard, network 12 then preferably comprises the Internet and the files on the server 14 comprises hypertext mark-up language files (HTML) such as are commonly accessed over the world wide web. It is further recognized that the files could be distributed throughout various servers 14, as is known.

In addition, system 10 may include Customer Processing System (CPS), a subsystem of the Verification Information Service (VIS), both of which are provided by the Department of Homeland Security. In one embodiment, a CPS module may be provided on server 14 (or a group of servers 14). CPS enables system 10 to communicate with E-verify.

E-verify is a web-based employment verification system that checks the validity of I-9 Form information, operated by the Department of Homeland Security (DHS) and the Social Security Administration (SSA). E-verify compares information provided on an employee's I-9 form against information in government records.

System 10 is thus configured to enable validation of the I-9s, which have been stored in the system, as often as requested, via E-verify. System 10 is also configured to store E-verify documents, which are necessary to be in compliance with DHS such as the Memo of Understanding, DHS referral letters sent to clients regarding the process, and other related E-verify materials.

For example, system 10 is configured to store Memo of Understanding Forms. To be able to participate in the Employment Eligibility Verification Program (E-verify), an employer must complete a Memo of Understanding Form. System 10 is configured to provide Memo of Understanding Forms, when requested by the employer (e.g., user of system 10). System 10 may also be configured to provide an interface via which the Memo of Understanding Form may be completed. System may also be configured to store a completed copy of the Memo of Understanding Form, which may be accessible via a link on an interface.

As another example, system 10 is configured to store DHS referral letters. In this regard, for example, during the E-verify process, DHS may require additional evidence and/or clarifications regarding an employee's eligibility for employment. To illustrate, DHS may determine, during a photo-matching process, that DHS's recorded photo of the I-9 applicant does not match the employer's records. DHS may therefore request the employer to compete a referral letter and provide related materials (e.g. photos and documents). System 10 may provide a number of templates of referral letters, which a user may access. To assist with the process of submitting and completing the referral letters, system 10 may provide an interface via which a user may fill out information pertaining to the requisite referral letter. System 10 may also be configured to pre-populate the interface with data that is already in the system 10, as discussed above, such that the user merely has to review, edit, and complete the referral letter, as necessary. System may also be configured to store a completed copy of the referral letter, which may be accessible via a link on an interface.

In addition, system 10 is configured to implement business rules that are in accordance with the procedures and rules set forth by DHS. For example, system 10 may be configured to prompt and request a user to specify an overdue reason (e.g. reason why the application was not submitted in a timely manner) when an employee is not E-verified within a particular time frame (e.g., 3 business days from a new hire's start date).

As another example, system 10 may be configured to check and ensure that the proper combination of documents are submitted as evidence based on, for example, a citizenship status of an I-9 applicant. That is, system 10 is configured to ensure that the appropriate documents are being submitted as evidence based on an I-9 applicant's citizenship status. For example, a U.S. citizen may submit an unexpired U.S. passport as evidence, while a permanent resident may submit an I-551 Permanent Resident card along with their Social Security card.

System 10 is also configured to perform an initial review and check of I-9 materials before connecting with E-verify. As an example, system 10 is configured to check expiration dates and document formats before connecting with E-verify. In other words, system 10 is configured to ensure that the date of a submitted document is valid and will not allow a user to submit a document that has expired. System 10 is further configured to check and ensure that the data, which is received and input, is of the correct format (e.g., SSN is 9 digits and of the xxx-xx-xxxx format, alien number is 9 digits and of the correct format, I-94 number is 11 characters and of the correct format, and etc.).

The E-verify service, which is implemented by system 10, is beneficial to employers, as the law requires businesses that employ foreign workers in the United States to verify that their employees have the necessary authorization to work in the U.S. In addition, this is particularly beneficial to federal contractors and subcontractors, which are required to electronically verify all employees working on a federal contract.

In any event, in the embodiment set forth in the figures, a system preferably is provided for the delivery of services relating to employment eligibility and verification. In particular, the illustrated system facilitates the processing and management of I-9 applications, as well as related materials.

Familiarity with basic terms used in the field of employment eligibility and verification is assumed. However, it is to be understood that the described embodiment is for illustrative purposes only, as the invention has application in other areas.

In the illustrated embodiment, the system provides a network access site, preferably a world wide web site which a client can visit using known browser software packages. Such sites comprise hypertext mark-up language (HTML) files.

As is typical for sites on the world wide web, in addition to textual information and/or other multimedia information, the pages include hyperlinks to other pages or sites or HTML files, which can also be considered interfaces. Unless otherwise noted herein, the terms web site, web page, page and HTML file are used interchangeably herein. Thus, the client can be redirected to specific interfaces, depending upon the hyperlink chosen.

As described above, system 10 provides a means for automating, gathering, receiving, displaying, tracking, and managing information relating to employment eligibility and verification over a network access site. In this regard, for example, network access site may include a number of user interfaces that enable a user to create, prepare, store, search, manage, track, and audit any number of I-9 forms and related materials. In addition, the network access site may include a user interface in which a user may post questions and/or comments, and receive immediate feedback, and/or a user interface in which a user may submit an audit request.

The network access site is configured to provide secure communications between a user and system 10. The network access site may therefore require an authorized user to be registered with the system. Once a user is registered and logged-in, system 10 may present the user with the option of creating an I-9 for an individual. This option may include, for example, a menu that allows the user to select an existing account of the system or to select a new account.

An existing account may refer to an account in which the individual (“the I-9 applicant”) already has some information available and stored in the system. For an existing account, system 10 will automatically fill and/or supply any fields of data (e.g., first name, last name, address, and etc.) that is required by the system 10 based on data of the existing account in the relevant user interfaces so that a user merely has to review and/or amend these fields for accuracy. Additionally and/or alternatively, system may utilize information that is received via the I-9 process to further assist with other actions, applications, and data relating to the existing account.

Upon receiving information to create an I-9 for an existing account or to create an I-9 for a new account, system 10 is configured to provide a user with a user interface to set up an employee account and start a new I-9.

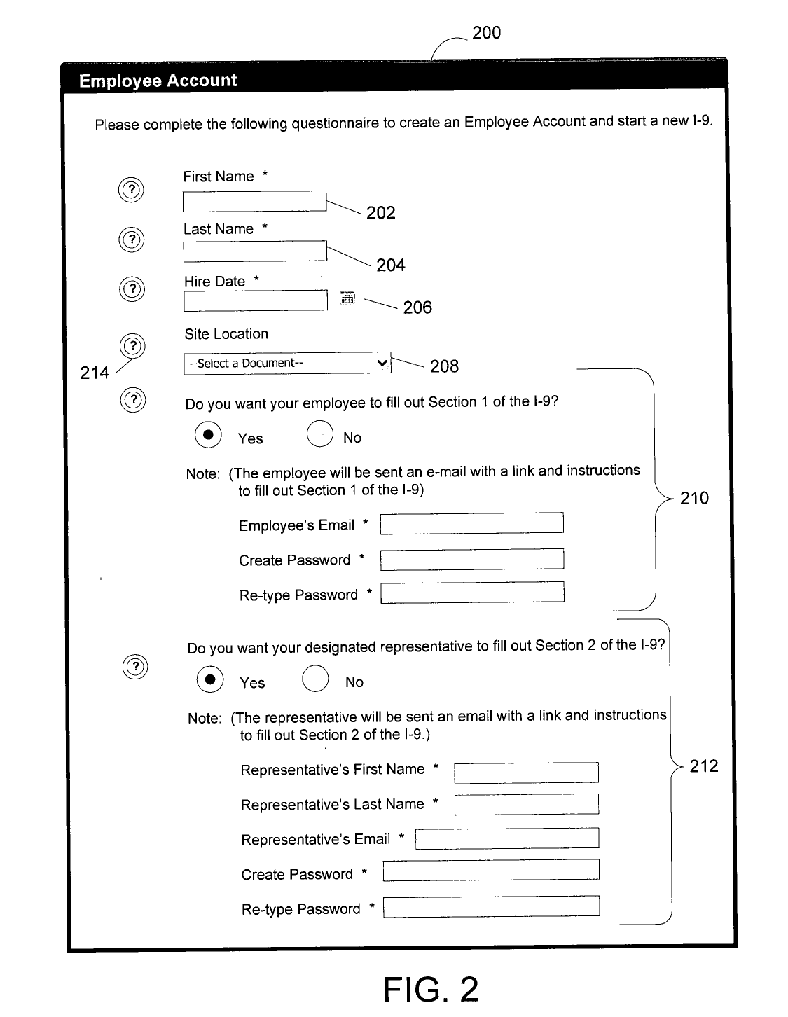

FIG. 2 illustrates an exemplary user interface that allows a user to set up an employee account and start a new I-9. User interface 200 may include a number of required fields, which may be designated, for example, with a mark, such as an asterisk. The required fields may include a first name field 202, a last name field 204, and a hire date field 206 of the new employee. In addition, user interface 200 may include a site location field 208 requesting the site location of the new employee.

User interface 200 may include section 210 that allows a user (e.g., an HR representative) to indicate whether or not the employee will fill out section 1 of the I-9. Based on the response to this inquiry, system 10 will determine whether or not an employee account will be set up to provide an employee with limited access to the system.

With regards to setting up an employee account that allows the employee to access limited information (e.g. only certain information pertaining to the employee), user interface 200 may include an employee's e-mail address field, which requires input of the employee's e-mail address. In addition, user interface 200 may include a password field, as well as a password confirmation field, to set up an initial password for the employee's account with system 10.

In one embodiment, if a user (e.g., HR representative) opts to have the employee (i.e., I-9 applicant) fill out section 1 of the I-9, then the system will send an e-mail to the I-9 applicant in accordance with the address specified in the employee's e-mail address field. The e-mail, generated by system, may include a customized message for the I-9 applicant regarding the I-9 process and requirements, as well as a due date for completing section 1 of the I-9. In this regard, the message may include a list of acceptable documents from lists A, B, and C, which the I-9 applicant may submit to prove his/her identity and eligibility for employment. The e-mail is configured to include a link, which, when activated, allows the I-9 applicant to log-in to the system by entering the requisite log-in information. The email may also notify the I-9 applicant of his/her password for logging into the system.

Once the I-9 applicant logs into the system, using the information set forth in user interface 200, the system directs the I-9 applicant to section 1 of the I-9 applicant's account.

Upon completing and submitting section 1 of the I-9, the system may be configured to provide the I-9 applicant with a confirmation receipt indicating that the I-9 applicant completed section 1 of the I-9 form. System may be configured to limit the I-9 applicant's access to section 1 of his/her I-9 form, provided that the I-9 applicant hasn't already submitted this information to the system.

User interface 200 may further include section 212 that allows a user (e.g., HR representative) to indicate whether or not a designated representative will fill out section 2 of the I-9. If a designated representative is selected, then section 212 may include fields requesting the following items of information: (1) representative's first name; (2) representative's last name; and (3) representative's e-mail address. In addition, section 212 may request the user to create a password for the designated representative and to re-type the password to confirm it.

In one embodiment, if a user (e.g., HR representative) opts to have the designated representative (i.e., employer's representative) fill out section 2 of the I-9, then the system will send an e-mail to the designated representative in accordance with the address specified in the designated representative's e-mail address field. The e-mail, generated by system, may include a customized message for the designated representative regarding the I-9 process and requirements, as well as a due date for completing section 2 of the I-9. In this regard, the message may include a list of acceptable documents from lists A, B, and C, which the designated representative may review to authenticate and prove the employee's (I-9 applicant's) eligibility for employment. The e-mail is configured to include a link, which, when activated, allows the designated representative to log-in to the system by entering the requisite log-in information. The email may also notify the designated representative of his/her password for logging into the system.

Once the designated representative logs into the system, using the information set forth in user interface 200, the system directs the designated representative to section 2 for the corresponding I-9 applicant's account. Upon completing and submitting section 2 of the I-9, the system may be configured to provide the designated representative with a confirmation receipt indicating that the designated representative has completed section 2 of the I-9 form. System may be configured to limit the designated representative such that he/she may only access section 2 of the corresponding I-9 applicant's account, provided that the designated representative hasn't already submitted this information to the system.

User interface 200 may include a help icon 214 in association with a field or a section that is to be completed by a user. In one embodiment, user interface 200 is provided with a help icon for most (if not all) of the fields. When activated, help icon 214 is configured to provide a user with further information (e.g., a description) regarding the field and its requirements.

User interface 200 may provide the user with options (not shown), such as “Save and Continue,” “Save and New,” and “Cancel.” The “Save and Continue” option allows the user to save the information that has been input and navigate the user to the next action, which may be based on the user's input. For example, if the user indicates that the employee will not fill out section 1 of the I-9, then the user is navigated to section 1 of the I-9 so that the user may enter information. The “Save and New” option allows the user to save the information that has been input and create another new employee account. The “Cancel” option allows the user to cancel this new employee account.

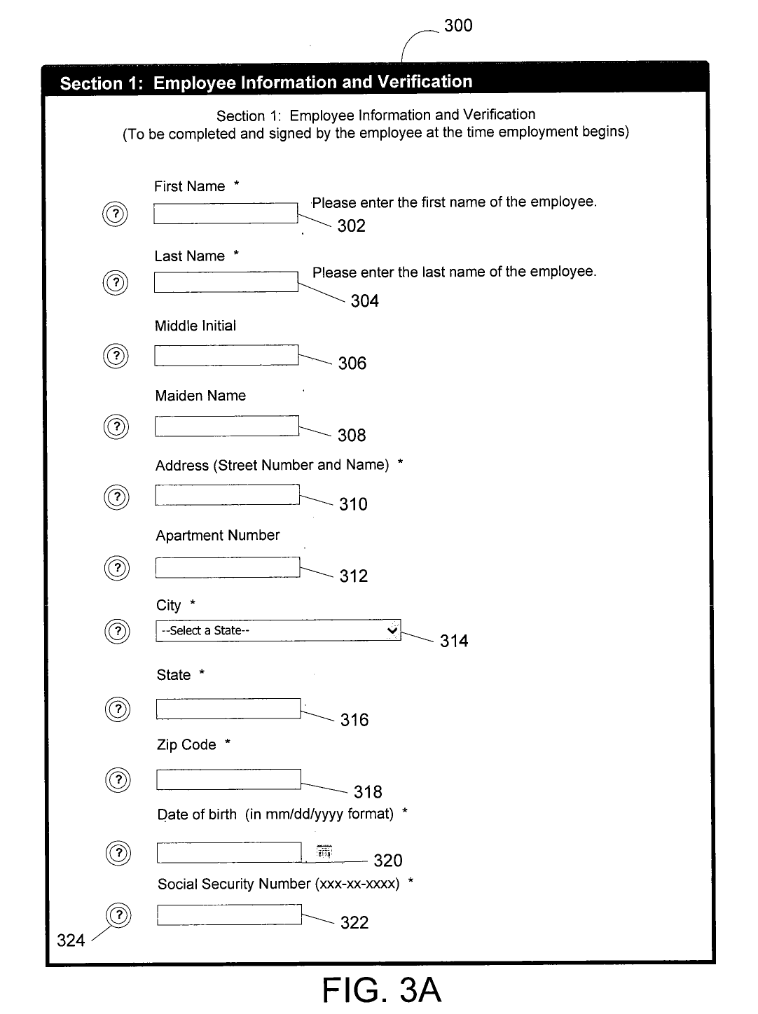

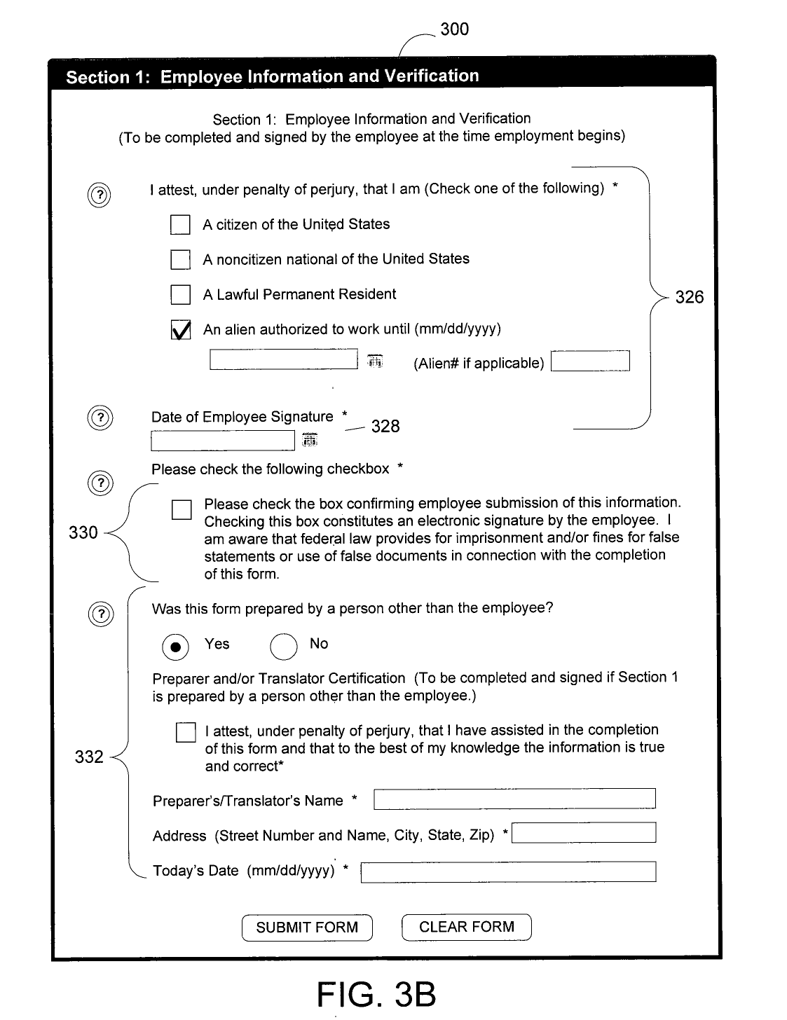

FIGS. 3A-3B illustrate an exemplary user interface in which information relating to section 1 of the I-9 form can be input. In accordance with section 1 of the I-9 form, user interface 300 may display a message that indicates that this section is to be completed and signed by the employee at the time employment begins.

User interface 300 includes a number of fields corresponding to all items, which are required in section 1 of the I-9 form. In this regard, the required fields may be designated, for example, with a mark such as an asterisk on user interface 300. In addition, user interface 300 may include a help icon 324 in association with a field. In one embodiment, user interface is provided with a help icon for each field. When activated, help icon 324 is configured to provide a user with further information (e.g., a description) regarding the field and its requirements.

For example, user interface 300 includes a first name field 302, a last name field 304, a middle initial field 306, a maiden name field 308, an address field (i.e., street number and street name) 310, an apartment number field 312, a city field 314, a state field 316, a zipcode field 318, a date of birth field 320, and a social security number (SSN) field 322. Each of the fields are labeled with a field descriptor so that the user knows what information is required for each field. In addition, the field descriptor may indicate the format that the data is to be input into the field. For example, the date of birth field includes a “Date of birth (in mm/dd/yyyy format)” label in which “(in mm/dd/yyyy)” indicates the format that the date of birth should be entered into the system.

User interface 300 further includes section 326 which is required on the I-9 form. Section 326 includes the statement, “I attest, under penalty of perjury, that I am (check one of the following):” along with a number of checkboxes in association with a number of categories. In accordance with the I-9 form, section 326 includes a checkbox in association with “A citizen of the United States,” a checkbox in association with “A noncitizen of the United States (see instructions),” a checkbox in association with “A lawful permanent resident (Alien #),” a checkbox in association with “An alien authorized to work (Alien # or Admission #).”

If the checkbox associated with “A lawful permanent resident (Alien #)” is selected and/or checked, then the employee's alien number is required to be input into a field associated with “A lawful permanent resident.” If the checkbox associated with “An alien authorized to work,” then the last day in which the alien is authorized to work should be entered into a field which is allotted for that purpose along with the employee's alien number and/or admission number (if applicable).

User interface 300 includes section 328 for entering a date of the electronic employee's signature, and section 330, which requires the employee to check the checkbox that is associated with the following message: “Please check the box confirming employee submission of this information. Checking this box constitutes an electronic signature by the employee. I am aware that federal law provides for imprisonment and/or finds for false statements or use of false documents in connection with the completion of this form.”

User interface 300 includes section 332. Section 332 requires the employee to indicate if this section was prepared by the employee or by a person other than the employee. If the form was prepared by the employee, then no further information is required by the employee in section 332.

In the event that the form was prepared by a person other than the employee, then section 332 requires certification by the preparer and/or translator. Section 332 thus includes a preparer's/translator's name field, an address field, and a current date field (“Today's Date (mm/dd/yyyy)” field). Section 331 further requires the preparer/translator to attest, via a checkbox, to the following statement: “I attest, under penalty of perjury, that I have assisted in the completion of this form and that to the best of my knowledge the information is true and correct.”

User interface 300 includes a “Submit Form” option, which allows the employee to submit section 1 of the I-9 form to the system. User interface 300 may include a “Clear Form” option, which, when activated, clears all of the fields of section I.

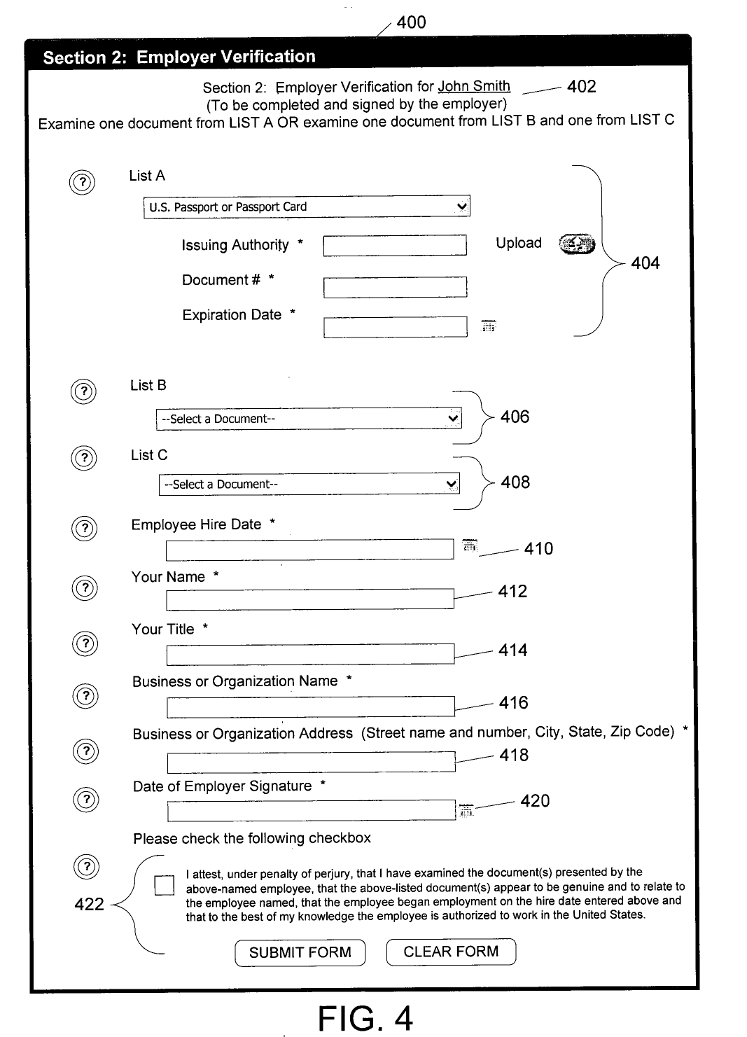

FIG. 4 is an illustration of an exemplary user interface that is configured to receive information relating to section 2 of the I-9 form. In accordance with section 2 of the I-9 form, user interface 400 may display a message that indicates that this section is to be completed and signed by the employer. User interface 400 is configured to include section 402, which identifies the I-9 applicant (i.e., the newly hired employee).

User interface 400 includes a number of fields corresponding to all items that are required in section 2 of the I-9 form. In this regard, the required fields may be designated, for example, with a mark such as an asterisk on user interface 400. In addition, user interface 400 may include a help icon in association with a field. In one embodiment, user interface is provided with a help icon for each field. When activated, help icon is configured to provide a user with further information (e.g., a description) regarding the field and its requirements.

In accordance with section 2 of the I-9 form, user interface 400 is configured to display a message that indicates that the employer is to examine one document from List A, or examine one document from List B and one from List C.

User interface 400 includes a List A section 404, a List B section 406, and a List C section 408. List A section 404 may include a drop down menu, which provides a listing of each of the documents that could be submitted as a List A document as set forth in the I-9 requirements. List B section 406 may include a drop down menu, which provides a listing of each of the documents that could be submitted as a List B document as set forth in the I-9 requirements. List C section 408 includes a drop down menu, which provides a listing of each of the documents that could be submitted as a List C document as set forth in the I-9 requirements.

In accordance with the I-9 requirements, a List A document may comprise a (1) U.S. passport or U.S. passport card, (2) Permanent Resident Card or Alien Registration Receipt Card (From I-551), (3) Foreign passport that contains a temporary I-551 stamp or Form I-94 or Form I-94A, (4) Employment Authorization Document that contains a photograph (Form I-766), or (5) Passport from the Federated States of Micronesia (FSM) or the Republic of the Marshall Islands (RMI) with Form I-94 or Form I-94A.

In accordance with the I-9 requirements, a List B document may comprise a (1) Driver's license or U.S. State issued photo ID card, (2) a photo ID card issued by federal, state, or local government agencies or entities, (3) school ID card with a photograph, (4) voter's registration card, (5) U.S. military card or draft record, (6) military dependent's ID card, (7) U.S. Coast Guard Merchant Mariner Card, (8) Native American tribal document, and (9) Driver's license issued by a Canadian government authority. For persons under age 18, who are unable to present one of the above-mentioned documents, a List B document may comprise (1) school record or report card, (2) clinic, doctor, or hospital record, and (3) day-care or nursery school record.

In accordance with the I-9 requirements, a List C document may comprise a (1) U.S. SSN card, (2) birth certificate, (3) Native American tribal document, (4) U.S. Citizen Identification Card, and (5) Employment Authorization document issued by Department Of Homeland Security.

When a document name is selected from any of the drop down menus, then the system is configured to provide a means by which the employer may provide information (e.g., title, number, and expiration date), if any, pertaining to the selected document and submit a copy of the selected document to the system.

As an example, if “U.S. Passport or Passport Card” is selected from the drop down menu provided in List A section 404, then user interface 400 includes fields relating to the passport, such as an issuing authority field, a document # field, and an expiration date field. As a means of submitting the selected document to the system, the system may be configured to provide a file upload option in which the selected document may be uploaded to the system. In addition, once a submission has been made, the user interface is then configured to display a “View Document” option and a “Replace Document” option.

The “View Document” option, when activated, enables a user to view a copy of the submitted document (e.g., Passport). The “Replace Document” option, when activated, enables a user to view a replace a previous submission with another submission for the selected document.

User interface 400 further requires the employer to provide the employee hire date and includes field 410 for a user to input this information into the system. The employer, who is completing section 2, is further required to provide his/her personal information and his/her employer information in fields 412-418. These fields include a name field 412, a title field 414, a business/organization name field 416, a business/organization address field 418. Name field 412 is for the employer to enter his/her name. Title field 414 is for the employer to enter his/her title. Business/organization field 416 and business/organization address field 418 are fields in which the employer may enter the employer's business/organization name and address.

User interface 400 includes section 422 in which the employer is required to attest to the following statement: “I attest, under penalty of perjury, that I have examined the document(s) presented by the above-named employee, that the above-listed document(s) appear to be genuine and to relate to the employee named, that the employee began employment on the hire date entered above and that to the best of my knowledge the employee is authorized to work in the United States.” Together with this statement, user interface 400 may provide a checkbox that, when checked, indicates that the employer attests thereto.

User interface 400 also includes a “Date of Employer Signature” field 420 that is provided near the checkbox and the statement. The “Date of Employer Signature” field 420 is configured to receive the date that employer electronically signs section 2 of the I-9 form for the employee.

User interface 400 includes a “Submit Form” option, which allows the employee to submit section 2 of the I-9 form to the system. User interface may include a “Clear Form” option, which, when activated, clears all of the fields of section 2.

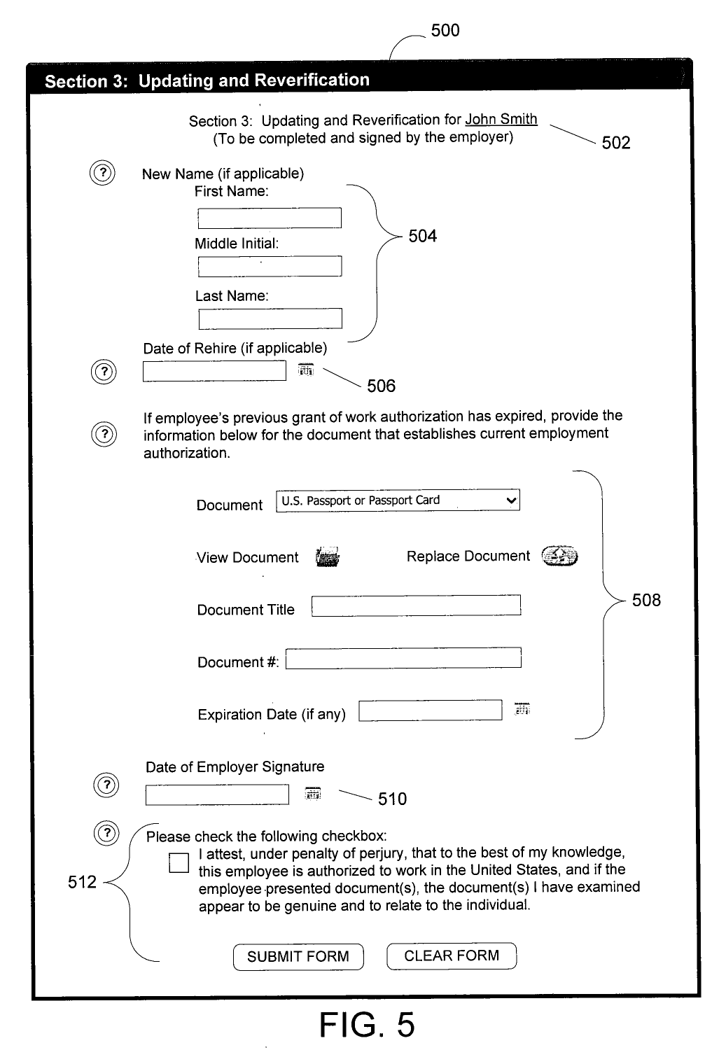

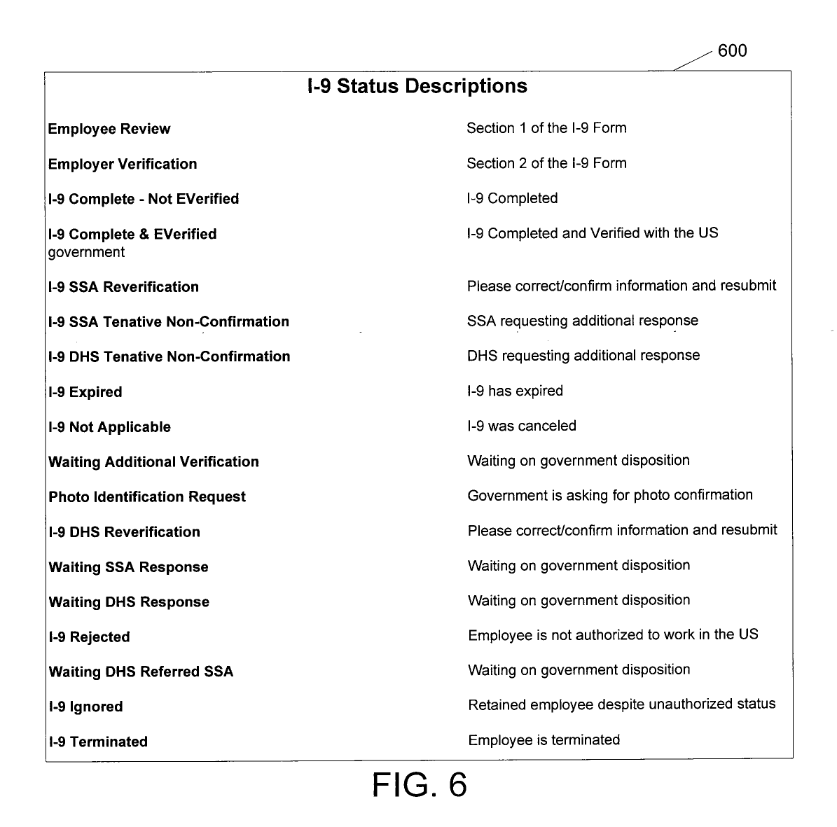

FIG. 5 is an illustration of an exemplary user interface that is configured to receive information relating to section 3 of the I-9 form. In accordance with section 3 of the I-9 form, user interface 500 may display a message that indicates that this section is to be completed and signed by the employer. User interface 500 is configured to include section 502, which identifies the I-9 applicant (i.e., the newly hired employee).

User interface 500 includes a number of fields corresponding to all items that are provided and/or required in section 3 of the I-9 form. User interface 500 may include a help icon in association with a field. In one embodiment, user interface is provided with a help icon for each field. When activated, help icon is configured to provide a user with further information (e.g., a description) regarding the field and its requirements.

User interface 500 includes a number of fields that may be filled out by the employer, if applicable. In this regard, for example, user interface 500 includes section 504, which includes a new name field, if applicable, that allows a user to enter a first name into a first name field, a middle initial into a middle initial field, and a last name into a last name field. User interface 500 includes a date of rehire field 506, which may be entered by the employer, if applicable.

User interface 500 includes section 508 that enables the employer to provide information that establishes an employee's current employment authorization if the employee's previous grant of work authorization has expired. Section 508 may include a document name field, a document title field, a document number field, and an expiration date field. Document name field provides the name of the selected document (e.g., “Passport”). In association with the document name field, user interface 500 displays a file submission means (e.g., file upload option) if the selected document is not available or has not been submitted. If an existing file is available or has been submitted for the selected document, then user interface displays a “View Document” option and a “Replace Document” option. The “View Document” option, when activated, enables a user to view a copy of the submitted document (e.g., Passport). The “Replace Document” option, when activated, enables a user to replace a previous submission with another submission for the selected document.

User interface 500 includes a “Date of Employer Signature” field 510 that is provided near section 512. The “Date of Employer Signature” field 510 allows entry of the current date and/or the date that the employer electronically signs section 3 of the I-9 form for the employee.

User interface 500 includes section 512 in which the employer is required to attest to the following statement: “I attest, under penalty of perjury, that I have examined the document(s) presented by the above-named employee, that the above-listed document(s) appear to be genuine and to relate to the employee named, that the employee began employment on the hire date entered above and that to the best of my knowledge the employee is authorized to work in the United States.” In addition, section 512 includes a mechanism (e.g., a checkbox) by which the employer is configured to acknowledge that he/she attests thereto.

User interface 500 includes a “Submit Form” option, which allows the employer to submit section 3 of the I-9 form to the system. User interface 500 may include a “Clear Form” option, which, when activated, clears all of the fields of section 3 of the I-9 form for the employee, identified in section 502.

As discussed, FIGS. 2-5 relate to the creation and preparation of an I-9 for an individual. Obviously, the layout of interfaces 200, 300, 400, and 500 are not material. It is only important that these interfaces prompt and obtain all requisite information regarding each section of the I-9 from the respective specified user. That is, these interfaces are intended to gather information from the necessary individuals (e.g., employee and employer) to ensure that each I-9 form and/or account is completed and maintained, as required by the federal government.

Further, as discussed, each of the sections may be accessed and filled out at different times and by different authorized individuals (e.g., employee, preparer/translator, designated representative, and etc.). However, system 10 may be configured such that the questionnaire of user interface 200 should (and/or must) be completed before section 1, while section 1 should (and/or must) be completed prior section 2. In order to assist with the process of tracking, managing, maintaining, and auditing I-9s for a number of individuals, the system may associate each I-9 with a status that provides a quick reference and reflection of where the I-9 is in the process.

FIG. 6 is a listing of statuses that may be associated with an I-9 that is available in the system. The system is not limited to this set of I-9 status identifiers, but may include additional statuses to more narrowly define where the I-9 is in the process, or may include less status identifiers to more broadly define where the I-9 is in the process. In addition, system 10 is not limited to these status identifiers and/or descriptions, but may include other status identifiers and/or descriptions that provide a similar objective.

Statuses of an I-9, which may be utilized by the system, are as follows:
“Employee Review” indicates that section 1 of the I-9 form is waiting to be reviewed by the employee.
“Employer Verification” indicates that section 2 of the I-9 form is waiting to be reviewed by the employer.
“I9 Complete—Not E-verified” indicates that at least sections 1 and 2 of the I-9 form have been completed, but that the information provided on the I-9 has not been E-verified.
“I9 Complete & E-verified” indicates that at least sections I and II of the I-9 form have been completed, and that the information provided on the I-9 has been E-verified.
“I9 SSA Reverification” indicates that the system is awaiting for the information to be corrected and/or confirmed, as well as resubmitted to E-verify.
“I9 SSA Tentative Non-Confirmation” indicates that SSA is requesting additional response.
“I9 DHS Tentative Non-Confirmation” indicates that DHS is requesting additional response.
“I9 Expired” indicates that the I-9 has expired and/or the submitted documents have expired.
“I9 Not Applicable” indicates that the I-9 has been cancelled.
“Waiting Additional Verification” indicates that the system is waiting for the government's disposition.
“Photo Identification Request” indicates that the government has requested photo confirmation.
“i9 DHS Reverification” indicates that the system is waiting for the information to be corrected and/or confirmed, as well as resubmitted to E-verify.
“Waiting SSA Response” indicates that the system is waiting for the government's disposition (i.e., SSA's response).
“Waiting DHS Response” indicates that the system is waiting for the government's disposition (i.e., DHS's response).
“I9 Rejected” indicates that the employee (or individual) is not authorized to work in the U.S.
“Waiting DHS Referred SSA” indicates that the system is waiting for the government's disposition.
“I9 Ignored” indicates that the employee has been retained despite the employee's unauthorized status. As an example, this status may occur if DHS and SSA have provided a final non-confirmation regarding the employee's I-9 information, and the employee has not been terminated.
“I9 Terminated” indicates that the employee is terminated.

The above-mentioned statuses are beneficial in indicating a current state of an employee's I-9 account with respect, for example, to the I-9 and E-verify process (if applicable). These statuses may be provided in association with I-9 accounts on a user interface so that the user may quickly and easily obtain this information. For example, system may provide a user interface that enable a user to view and/or access a subset, set, or comprehensive listing of I-9 forms, which have been created and stored in the system.

In one embodiment, system may include a user interface that displays a listing of I-9 cases (and/or accounts) that are considered “active,” as well as a user interface that displays a listing of I-9 cases (and/or accounts) that are not considered “active” (i.e., “complete”).

System may consider an I-9 to be “active” if the I-9 is in the process of being completed. For example, in one embodiment, which does not employ E-verify, system may consider an I-9 case to be “active” if all necessary sections (e.g., sections 1 and/or 2) of the I-9 form have not been completed. However, in another embodiment employing E-verify, system may consider an I-9 case to be “active” upon receiving a final confirmation/unconfirmation from E-verify.

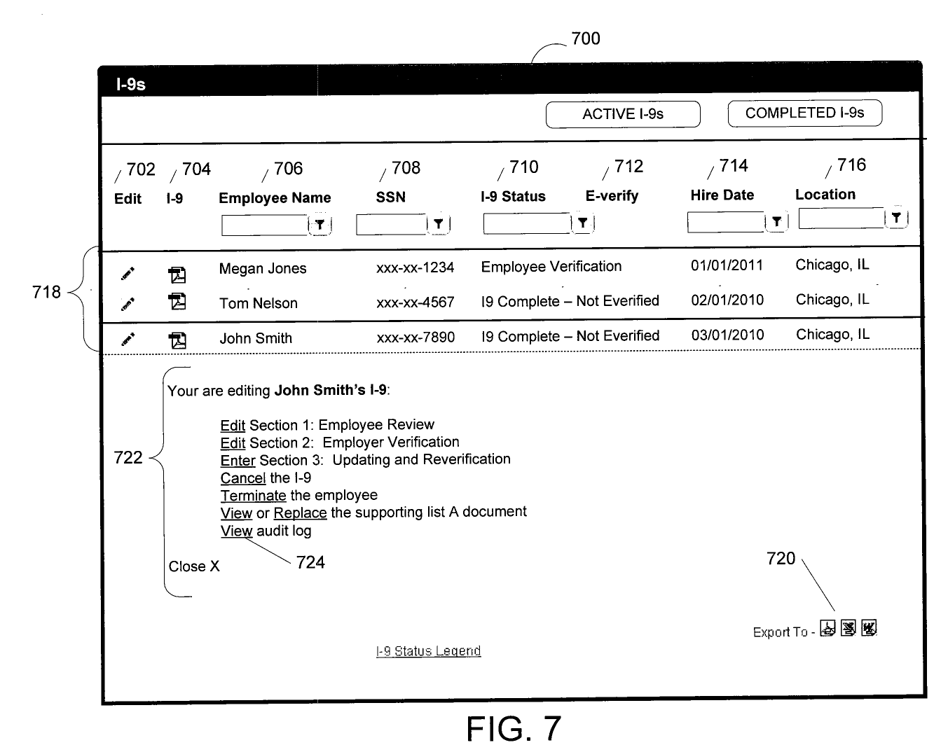

FIG. 7 is an illustration of an exemplary user interface that displays “active” I-9 forms. In this example, user interface 700 is associated with the utilization of E-verify to validate information of all of their I-9 forms. In such a case, the system is configured to classify an I-9 account as being “complete” when it has been E-verified.

User interface 700 may include a number of fields associated with the I-9 forms. In one embodiment, user interface includes an edit field 702, an I-9 field 704, an employee name field 706, a social security number (SSN) field 708, an I-9 status field 710, an E-verify field 712, a hire date field 714, and a location field 716. A search field may be provided in conjunction with a respective field so that a user may receive search results based on a particular value or input that is placed in the search field. In this example, user interface 700 includes a search field for the employee name field 706, a search field for the SSN field 708, a search field for the I-9 status field 710, a search field for the hire date field 714, and a search field for the location field 716.

User interface 700 includes section 718, which is configured to display a listing of cases. Section 718 may include a case, a set of cases, or a comprehensive listing of cases depending on a number of factors, such as whether or not search criteria have been entered or not. The listing has fields, which may be populated with information that has been extracted from the data that was submitted into the system via user interface 200, user interface 300, user interface 400 and/or user interface 500.

User interface 700 is configured to include section 720, which includes a listing of programs. The listing of programs may include, for example, Microsoft Word™, Microsoft Excel™, Adobe Acrobat™ product, and/or other application programs. Information, populating section 718 (e.g., search results, listing of “active cases,” and/or a comprehensive listing of cases) may be exported to a program, specified in section 720. For example, for purposes of creating a spreadsheet report, a user may choose to export a listing of cases, which is presented in section 718, pertaining to the status, “Employer Verification,” in the I-9 status field to Microsoft Excel™. This allows the information, which is stored in a database and/or server of the system, to be transferred and used in other systems.

As discussed above, user interface 700 includes a number of fields. A description of these fields is presented below.

Edit field 702 may include an icon, when activated, displays menu 722, in association with the corresponding I-9 account. Menu 722 provides a user with an option to view and/or access an audit log associated with the corresponding I-9 irrespective of the current status of the account. In addition, menu 722 may include other options, which may be provided, based upon the current status of the I-9 application. For example, an employee will have a greater number of menu options as the employee is further along in the I-9 application process than when the employee has just started the I-9 application process.

For example, as shown in this case, John Smith's I-9 is shown to be complete, but has not been E-verified. In other words, all of the necessary sections (e.g., sections 1 and 2) of John Smith's I-9 are complete, but the information has not been confirmed or unconfirmed by the federal government's E-verify system. As a result, when edit field 702 is activated, menu 722 includes the following menu options: (1) Edit Section 1: Employee Review; (2) Edit Section 2: Employer Verification; (3) Enter Section 3: Updating and Reverification; (4) Cancel the I-9; (5) Terminate the employee; (6) View or Replace the supporting list A document; and (7) View audit log. In other words, in John Smith's case, menu 722 provides a user with the option of editing sections 1 and 2 of the I-9, as shown in user interfaces 200 and 300, and entering information for section 3 of the I-9, as shown in user interface 400. With respect to John Smith's account, menu 722 also provides a user with the option of canceling the I-9 or terminating the employee in which case, if any of these options is selected, then John's Smith's I-9 would be considered “complete” and would no longer be provided on user interface 700. Menu 722 further provides a user with the option of viewing or replacing the supporting materials, which were submitted with respect to section 2 of the I-9 form. Menu 722 also provides a user with a link 724 to access audit log.

I-9 field 704 includes an icon, when activated, displays the actual I-9 form, which is populated by any information, which may have been submitted via at least one of user interface 300 (section 1 of the I-9 form), user interface 400 (section 2 of the I-9 form) and/or user interface 500 (section 3 of the I-9 form).

Employee name field 706 displays the name of the employee. Employee name field may include, for example, the first name field and the last name field, as discussed above.

SSN field 708 displays the SSN of the employee. For security and confidentiality purposes, SSN field 708 may be configured to display only a portion (e.g., last four digits) of the SSN. For example, SSN field 708 may be displayed as “XXX-XX-1234,” where the “X” indicates a digit of the employee's SSN. Although SSN field 708 may be configured to display only a portion of an employee's SSN, the corresponding search field for SSN field 708 allows a user to perform a search based on the entire string of digits or a portion thereof, as desired.

Status field 710 indicates the current status of the employee's I-9. Status field 710 may display a status, such as that discussed with respect to FIG. 6, based on a current state of the I-9.

E-verify field 712 indicates whether or not an I-9 has been E-verified, provided that the system has been set up to E-verify all I-9s.

Hire date field 714 indicates the date that the employee is/was hired.

Location field 716 indicates the current location of the employee.

As discussed, user interface 700 includes a listing of all I-9 forms that are “active” and in the process of being completed. In general, the system may be configured to consider an I-9 case to be “active” from the time that the I-9 is created to a time in which the I-9 is considered “complete,” assuming that the (1) the I-9 was not cancelled, (2) the employee was not terminated, (3) the I-9 was not rejected, and the (4) the I-9 has not expired. If any of these conditions occur between the time in which the I-9 was created and the time in which an I-9 was determined to be “complete,” then the system changes the classification of the I-9 from “active” to “complete.”

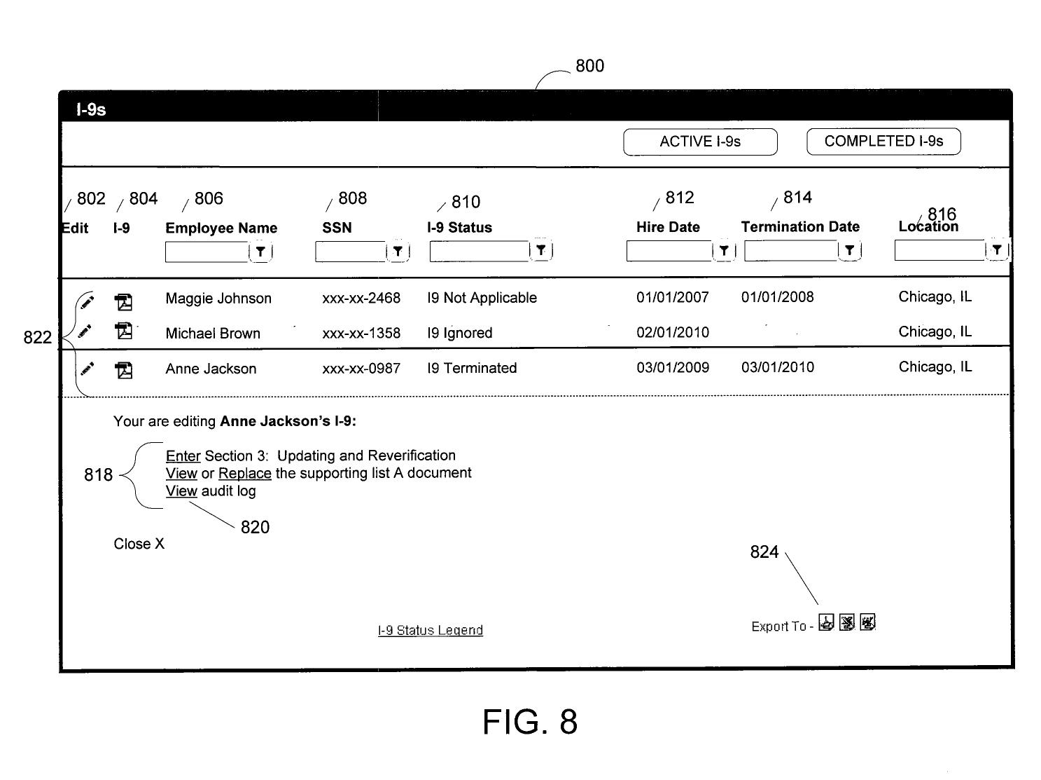

FIG. 8 is an illustration of an exemplary user interface that displays I-9 forms that have are considered “complete.” As discussed above, if an I-9 case is not considered “active,” then the I-9 is considered “complete.” User interface 800 displays a listing of I-9 cases (and/or acounts), which are considered to be “Completed I-9s.” As discussed above, if a system employs E-verify, then the basis of what the system considers “complete” is different than when the system does not employ E-verify.

User interface 800 may include a number of fields associated with the I-9 cases (and/or accounts). In one embodiment, user interface 800 may include an edit field 802, an I-9 field 804, an employee name field 806, an SSN field 808, an I-9 status field 810, a hire date field 812, a termination date field 814, and a location field 816. A search field may be provided in conjunction with a respective field so that a user may receive search results based on a particular value or input that is placed in the search field. In this example, user interface 800 includes a search field for the employee name field 806, a search field for the SSN field 808, a search field for the I-9 status field 810, a search field for the hire date field 812, a search field for the termination date field 814, and a search field for the location field 816.

User interface includes section 822, which is configured to display a listing of cases. Section 822 may include a case, a set of cases, or a comprehensive listing of cases depending on a number of factors, such as whether or not search criteria have been entered or not. The listing has fields, which may be populated with information that has been extracted from the data that was submitted into the system via user interface 200, user interface 300, user interface 400, and/or user interface 500.

User interface is configured to include section 824, which includes a listing of programs. The listing of programs may include, for example, Microsoft Word™, Microsoft Excel™, Adobe Acrobat™ product, and/or other application programs. Information, populating section 822 (e.g., search results, listing of “active cases,” and/or a comprehensive listing of cases) may be exported to a program, specified in section 824. For example, for purposes of creating a report, a user may choose to export a listing of cases, which is presented in section 822, pertaining to the status, “I9 Ignored,” in the I-9 status field to Microsoft Word™ or an Adobe Acrobat™ product. This allows the information, which is stored in a database or a server of the system, to be transferred and used in other systems.

Furthermore, as discussed with respect to FIG. 7, edit field 802, when activated, displays menu 818, in association with the corresponding I-9 account. Menu 818 may include a number of options, which may be provided, based upon the current status of the I-9 application. Further, each menu 818, regardless of the I-9 account or status of the account, also provides a user with an option to view and/or access an audit log 820 associated with the corresponding I-9.

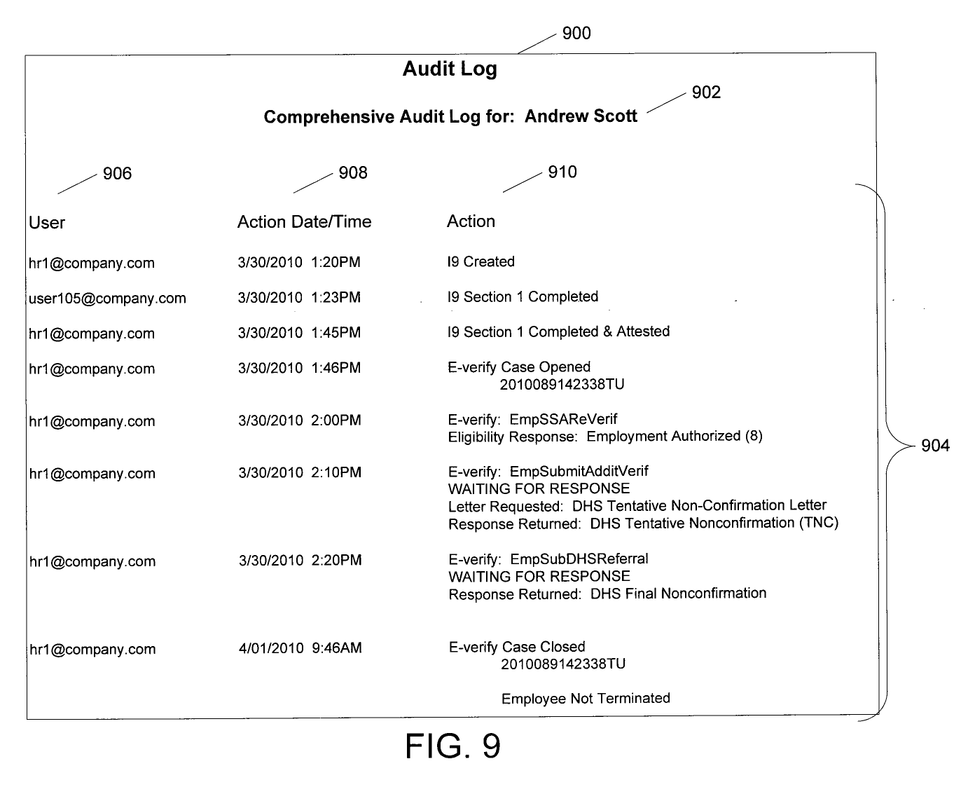

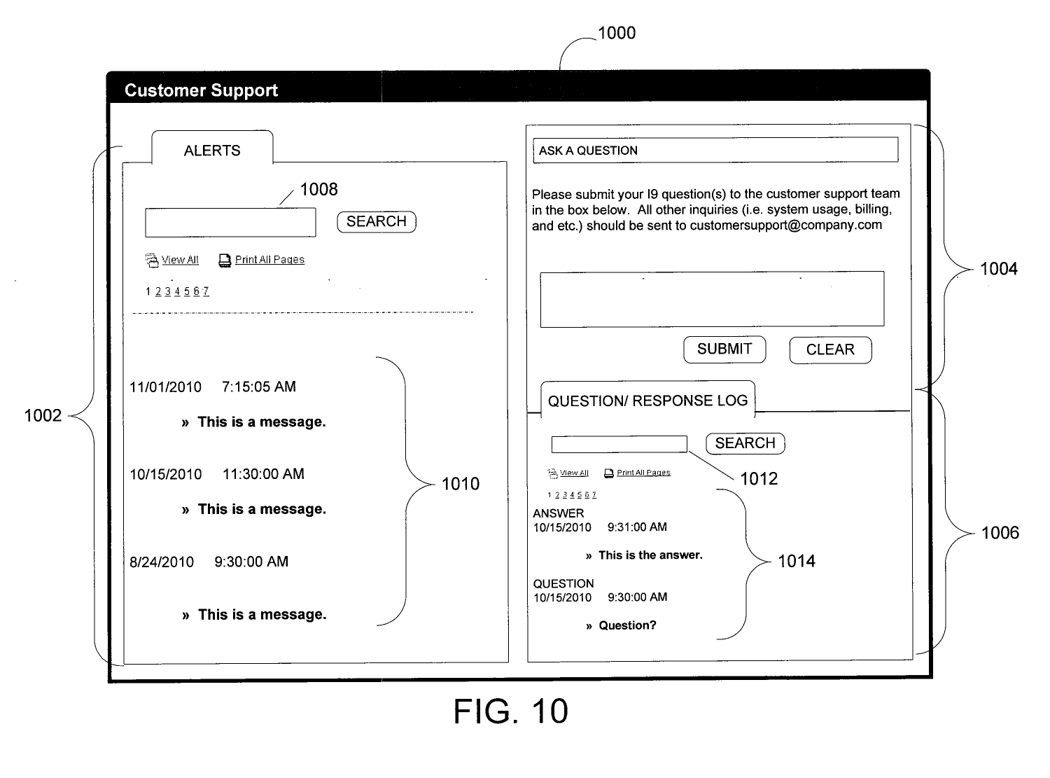

FIG. 9 illustrates an exemplary audit log of an I-9 account of an individual. As discussed, audit log 900 may be accessed via user interface 700 or via user interface 800. Audit log 900 is comprehensive and includes a listing of each action that occurred with respect to the I-9 from the time in which the I-9 was created.

Audit log 900 includes section 902, which identifies (or uniquely identifies) the individual associated with the I-9 form. For example, section 902 may include the first and last name of the I-9 applicant.

Audit log 900 includes log section 904 which identifies (or uniquely identifies) the user 906 that took action on the selected I-9 form in association with the action 910 and a timestamp 908 indicating when the respective action occurred.

In the example shown in FIG. 9, audit log 900 was established with respect to an I-9 applicant by the name of Andrew Scott. According to audit log 900, an I-9 was created for Andrew Scott on Mar. 30 2010 by hr1@company.com at 1:20 pm. Also, on Mar. 30, 2010, Andrew Scott (user105@company.com) completed section 1 of the I-9 form. Later that day, an HR representative (hr1@company.com) completed section 2 of the I-9 form. Information from Andrew Scott's I-9 was submitted to E-verify on Mar. 30, 2010. Audit log 900 indicates that Andrew Scott received a non-confirmation from E-verify. However, system further indicates that as of Apr. 1, 2010, Andrew Scott continues to be retained by his employer since there is no indication in the system that Andrew Scott has been terminated. Consequently, Andrew Scott's I-9 is considered “complete” since sections 1 and 2 have been completed and E-verified. Also, as of Apr. 1, 2010, Andrew Scott's I-9 account would be displayed in user interface 800 and would include an “19 Ignored” status.

As described above, FIGS. 6-9 illustrate a number of features associated with system 10 that allow a user to track, manage, maintain, and audit I-9s for a number of individuals. Should a user have a question and/or comment at any time while using the system, system 10 is further configured to provide a user with a customer support system.

FIG. 10 is an illustration of an exemplary customer support system, which is integrated into the system to provide immediate assistance and support regarding the I-9 process. Customer support system includes a user interface having a question/response log system. To assist users with I-9s, user interface 1000 includes a notification section 1002, a communication section 1004, and a log section 1006.

Notification section 1002 includes messages and/or alerts that are provided by the system. Each message is posted in the notification log 1010 and is accompanied by a timestamp to indicate the date and time in which a message was posted. Notification section 1002 may include a search field 1008 that provides a listing of any relevant messages, which meet the search criteria that have been entered.

Communication section 1004 includes a field that allows a user to pose a question and/or comment to a responsive support team (e.g., legal team) any time. Communication section 1004 provides unlimited consultation (e.g., legal consultation) with respect to I-9s. Communication section 1004 may include a submit option in which the user may submit the question and/or comment contained in the field to the system. Question section may further include a clear option that deletes any input, which is currently held in the field.

Once a question/comment has been submitted via the submit option, then the question/comment is posted to log 1014 together with a timestamp indicating the date and time the question/comment was submitted to the system (or received by the system). In addition, once a question/comment has been submitted, then the customer support team is notified. For example, the system may provide the question/comment in a queue, which is managed in an interface that is accessible by the customer support team. The customer support team is set up to provide an answer and/or response to the question/comment within 30 minutes or less from when the question/comment was submitted. The answer, provided by the customer support team, is also posted to log 1014 together with a timestamp indicating the date and time the answer was submitted to the system (or received by the system). System may be configured to send an e-mail to the user, which posted the question/comment, thereby notifying the user that a reply has been posted to his/her question/comment.

Furthermore, should a user have a substantial request with respect to the I-9s, which are currently available and stored in system, then the user may navigate to user interface 1100. User interface 1100 is configured so that a user may submit a request, which will be handled by trained and authorized personnel.

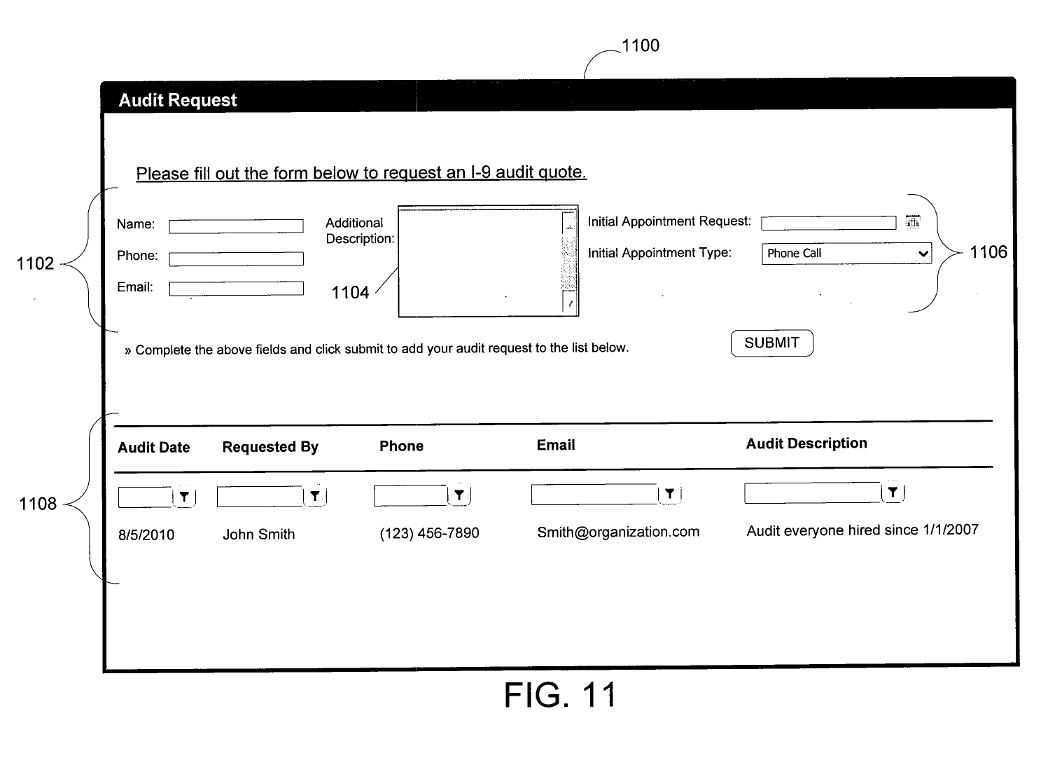

FIG. 11 is an illustration of an exemplary user interface that allows a user to communicate with trained and authorized personnel, affiliated with system, with respect to the I-9s, which are currently available and stored in system. In the example, shown in FIG. 11, the request is for an I-9 audit quote.

In this case, user interface 1100 includes a requestor section 1102 in which the user is to identify himself/herself and provide contact information. In this regard, for example, the user (or requestor) is configured to input his/her name into a name field, a phone number into a phone number field, an e-mail address into an e-mail field. User interface 1100 may include a comment section 1104 in which the requestor may provide additional details or comments regarding the request. User interface 1100 may include an appointment section 1106 in which a user may specify and request an appointment for communicating with the trained and authorized personnel. Once a request has been submitted with at least any of the aforementioned information, then the request is posted to request log 1108 of user interface 1100.

Request log 1108 is configured to provide a listing of each request that was made and/or performed. In this example, regarding an audit request, request log 1108 may include an audit date field, a requestor field, a phone number field, an e-mail field, and an audit description field. Request log 1108 may include a search field in association with at least one of the fields provided therein by which a user may search for a particular request and/or a set of requests, stored in request log 1108.

The above-described embodiments were implemented using the SharePoint™ suite of applications available from Microsoft Corporation. Other embodiments may be provided using other off-the shelf applications.

Although modifications and changes may be suggested by those skilled in the art, it is the intention of the inventors to embody within the patent warranted hereon all changes and modifications as reasonably and properly come within the scope of their contribution to the art.

What is claimed is:

1. A network based system for providing employment eligibility and verification services, said system comprising:
a first interface configured to obtain a first set of information to be associated with an account and stored in a database, the first interface being privileged to a first user of the system;
a second interface configured to obtain a second set of information to be associated with the account and stored in the database, the second interface being privileged to a second user of the system;
a file management interface configured to display a link to the account and a status of the account; and
an audit log configured to capture an action that is taken with respect to the account,
wherein,
the file management interface includes a link to the audit log.

2. The system of claim 1, wherein the audit log identifies a user that performed the action in association with a timestamp that indicates when the action occurred.

3. The system of claim 1, wherein the second interface provides an upload feature in which supporting materials related to the account may be provided to the system via the second interface.

4. The system of claim 3, wherein the file management interface includes a link to access the supporting materials.

5. The system of claim 4, wherein the file management interface includes a link that enables the supporting materials to be replaced by other supporting materials.

6. The system of claim 1, wherein the first set of information corresponds to section 1 of an I-9 form.

7. The system of claim 1, wherein the second set of information corresponds to section 2 of an I-9 form.

8. The system of claim 1, wherein the system is configured to (a) create a log-in account for the first user to access the first interface, and (b) create a log-in account for the second user to access the second interface.

9. A network based system for providing employment eligibility and verification services, said system comprising:
a file management interface configured to display at least one account along with a status of the account; and
a module configured to communicate with E-verify to validate information that has been electronically received with respect to the account,
wherein,
the system is configured to (a) check that an expiration date of a submitted document of the account is valid prior to communicating with E-verify regarding the account, and (b) update the status of the account on the file management interface based on a result provided by E-verify.

10. The system of claim 9, wherein the system is configured to determine if the appropriate documents are being submitted as evidence based on a citizenship status of the account, said determination occurring prior to communicating with E-verify.

11. The system of claim 9, wherein the system is configured to check whether or not the account has been submitted to E-verify within three business days from an employment start date, said system being configured to prompt a user to provide an overdue reason if the account has not been submitted to E-verify within three business days.

12. A network based system for providing employment eligibility and verification services, said system comprising:
a file management interface configured to:
(a) display a listing of I-9 account information that identifies I-9 accounts and provides statuses of the corresponding I-9 accounts,
(b) provide a status search field via which search results may be generated as the listing of I-9 account information based upon search criteria relating to a status of an I-9 account, and
(c) provide respective links to a set of programs,
wherein,
when a program from the set of programs is selected, the system is configured to provide the I-9 account information displayed in the file management interface to the selected program to generate a report of the I-9 account information in a format of the selected program.

13. The system of claim 12, wherein, the set of programs includes Microsoft Word™, Microsoft Excel™, and an Adobe Acrobat™ application program.

14. The system of claim 12, further comprising:
an interface having a query section configured to receive a comment and post the comment into a log,
wherein,
the system is configured to notify a legal services provider of receipt of the comment and prompt the legal services provider to respond.

15. The system of claim 14, wherein the system is configured to send a notification e-mail to a user that posted the comment when the legal services provider posts a reply to the comment in the log.

16. The system of claim 12 further comprising:
an interface configured to display a notification log of messages and/or alerts relating to I-9 subject matter,
wherein,
the legal services provider contributes to the messages and/or alerts that are posted to the notification log.

17. The system of claim 16, wherein the system is configured to send a notification e-mail when a message and/or alert is posted to the notification log.

18. The system of claim 12, wherein the system stores the I-9 account information in an electronic data repository, and the I-9 account information is serialized into a format of the selected program.
